(19) United States
(12) Patent Application Publication
(10) Pub. No.: US 2005/0033464 A1
(43) Pub. Date: Feb. 10, 2005

(54) Real time closed-loop process control system for defect prevention

(75) Inventor: Tuan Minh Nguyen, Munich (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Dematic Electronics Assembly Systems, Inc.

(21) Appl. No.: 10/899,406

(22) Filed: Jul. 26, 2004

Related U.S. Application Data
(60) Provisional application No. 60/493,062, filed on Aug. 6, 2003.

(51) Int. Cl. G06F 19/00

(52) U.S. Cl. 700/108; 700/110

(57) ABSTRACT

A method is provided for executing a monitoring process during a manufacturing process to produce products. The method measures, in real time, performance variables of an upstream portion of a present manufacturing process, analyzes, with a processor, trends in the performance variables of the present manufacturing process together with data that models a portion of a subsequent manufacturing process, that occurs after the present manufacture process, to predict performance of the subsequent manufacturing process, sends trend analysis information to the present manufacturing process, and sends information to the subsequent manufacturing process.

This application is based on U.S. Provisional Application No. 60/493,062, filed on Aug. 6, 2003 and claims the benefit thereof for priority purposes.

### FIELD OF THE INVENTION

The invention relates to manufacturing methods and, more particularly, to a manufacturing methodology based on a real-time, closed-loop and forward-looking process control to prevent defects from occurring in production lines or manufacturing cells.

### BACKGROUND OF THE INVENTION

In the electronic manufacturing domain today, quality levels cannot be significantly improved without a major change in the way production lines and processes are controlled. The current practice focuses only on the containment of defects, which are measured in DPMO (defects per million opportunities). Defect containment is a passive manufacturing control mode.

Thus, there is a need to provide a manufacturing methodology based on a real-time, closed-loop and a forward-looking process control system to prevent defects from occurring in production lines or manufacturing cells.

### SUMMARY OF THE INVENTION

An object of the invention is to fulfill the need referred to above. In accordance with the principles of the present invention, this objective is achieved by providing a method for executing a monitoring process during a manufacturing process to produce products. The method measures, in real time, performance variables of an upstream portion of a present manufacturing process; analyzes, with a processor, trends in the performance variables of the present manufacturing process together with data that models a portion of a subsequent manufacturing process, that occurs after the present manufacture process, to predict performance of the subsequent manufacturing process; sends trend analysis information to the present manufacturing process; and sends information to the subsequent manufacturing process.

In accordance with another aspect of the invention, a computer readable medium has stored thereon, sequences of instruction for executing a monitoring process to prevent defects in products produced during a manufacturing process. The sequence of instructions include instructions for performing the steps of measuring, in real time, performance variables of an upstream portion of a present manufacturing process; analyzing, with a processor, trends in the performance variables of the present manufacturing process together with data that models a portion of a subsequent manufacturing process, that occurs after the present manufacture process, to predict performance of the subsequent manufacturing process; sending trend analysis information to the present manufacturing process; and sending information to the subsequent manufacturing process.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is a schematic illustration of a real time closed-loop process control system in accordance with an embodiment of the present invention.

FIG. 2 is a more detailed schematic illustration of a real time closed-loop process control system of FIG. 1.

FIG. 3 is a block diagram of a process of preventing defects in a manufacturing process in accordance with an embodiment of the invention.

### DETAILED DESCRIPTION OF THE PRESENTLY PREFERRED EXEMPLARY EMBODIMENT

A new manufacturing methodology based on a real-time, closed-loop and forward-looking process control system is provided to prevent defects from occurring in production lines or manufacturing cells. This process control system measures, in real time, key performance variables of a process using process sensory system (e.g. intelligent inspection system).

The process control methodology of the embodiment is a part of an entire solution covering all key manufacturing steps such as 1) Manufacturing Process Design and Process Development, 2) Process execution/implementation with real time process performance data collection, 3) Real time review and analysis of the process performance data to determine significant process trends and potential shifts, Corrective action on both sides of the process (downstream and upstream).

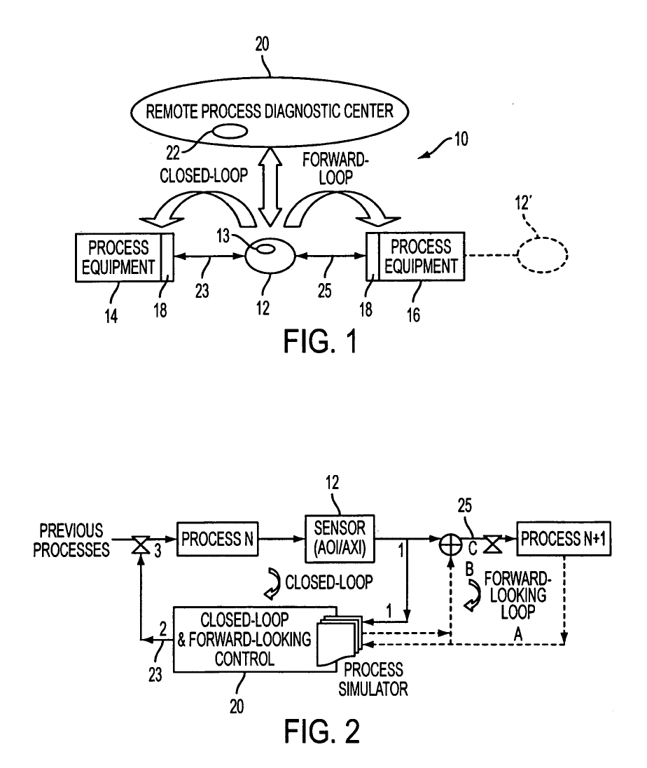

With reference to FIG. 1, a real time closed-loop process control system is shown, generally indicated at 10. A function performed in the process loop of the system 10 is to determine potential drift in the process where many process variables have been pre-selected as key control variables.

A process sensory system 12 measures, in real time, the key performance variables of an upstream portion of a manufacturing process. The sensory system 12 delivers information relating to the key control variables to the upstream process equipment 14 and downstream process equipment 16. The sensory system 12 can be, for example, conventional Automatic Optical Inspection (AOI) equipment. An example of information delivered is:
Process equipment name (can be read form a barcode)
Subsystem ID (Gantry, or Portal ID etc.)
Tool ID
Measurement data related to Subsystem and Tool
Part/Component name
Part/Component specific process data
Part/Component Presence/Absence—Present or Absent
Part/Component Alignment—Measurement of position relative to set point
Part/Component Rotation—Rotation measurement relative to set point.
Part/Component Polarity—Polarity Correct or Incorrect

The logic for the process control methodology of the system is preferably implemented as executable code. The code can be executed by a processor 13 associated with the sensory system 12. The logic compares the present variable measurement data to a running average of the last 5 measurements and determine if the difference is within upper and lower limits.

Action and/or warning will be triggered when a key control variable exceeds an upper or lower set point limit. A warning is generated even if the condition has not surpassed any initial pre-configured rules based conditions.

Warnings are issued also by the intelligent sensory system 12, which has embedded and advanced statistical analysis capability such as:
2 out of 3 points outside 2 sigma
4 out of 5 points outside 1 sigma
6 points Up/Down
8 consecutive points with nothing in 1 sigma zone etc.

If a warning is triggered, the sensory system 12 can access a remote process diagnostic center 20 to retrieve a suggested remedy or corrective action stored in a customizable knowledge database 22. It can be appreciated that instead of providing the remote database 22, the database 22 can be provided locally at sensory system 12. The corrective action is then outputted via communication link 23 to the appropriate equipment interface 18 and the upstream process parameters of equipment 14 are automatically adjusted, or an operator is notified to make the adjustments manually. The knowledge database 22 is then updated with the last event. The sensing system 12 also forwards operational information via communication link 25 to the downstream process equipment 16 to alert potential problems so that adequate changes can be made. For example, instructions can be provided to the downstream process equipment 16 not to place an item on a component that was misplaced by the upstream process equipment 14. In an assembly line, other sensory systems 12′ can be provided at various locations between upstream and downstream equipment.

FIG. 2 shows in more detail, the closed loop process together with the forward-looking loop of the embodiment. Thus, in the closed-loop process data coming from sensor 12 at via line 1 is processed by the Closed-Loop Control (or diagnostic center) 20 to calculate process performance 2 and dependent subsequent commands/warnings data 3 will be generated for the preset process (Process N). In the forward-looking loop, data coming from sensor 12 via line 1 is processed together with data model A of the subsequent process (Process N+1) to simulate and predict potential performance B of the subsequent process and dependent commands/warnings data C are issued for the subsequent process. Thus, at the Process N+1, a parameter of this portion of the process can be adjusted to prevent errors at this portion of the process. It can be appreciated that the method of the embodiment involves two consecutive processes.

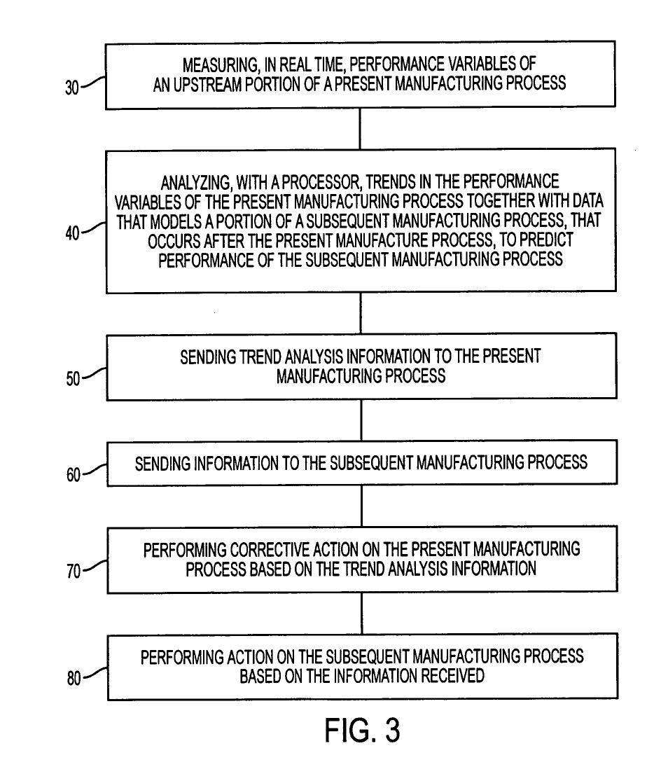

In accordance with the embodiment, a method of executing a monitoring process to prevent defects in products produced during a manufacturing process is shown in FIG. 3. The steps described in FIG. 3 can be implemented as executable code stored on a computer readable medium (e.g., hard dish drive, floppy drive, a random access memory, a read only memory, an EPROM, a compact disc, etc.).

In step 30, performance variables of an upstream portion of a manufacturing process are measured in real time via the sensory system 12. In step 40, trends in the performance variables of the upstream portion of the manufacturing process are analyzed together with data that models a portion of a subsequent manufacturing process, that occurs after the present manufacture process, to predict performance of the subsequent manufacturing process. The trends and information are analyzed using a processor associated with the sensory system 12. The information is sent via communication link 23 (FIG. 2) to the present manufacturing process (e.g., equipment 14) in step 50. In step 60, information is sent to the subsequent manufacturing process via line 25. In step 70, a corrective action is performed on the present manufacturing process based on the trend analysis information, before erroneous products are produced. Action is can be performed in step 80 on the subsequent manufacturing process such as parameter adjustment to ensure erroneous product is not produced. Steps 30, 40, 50, 60 are performed by the sensory system 12 and steps 79 and 80 are performed automatically or manually at the process equipment 14. The software executing steps 30-80 can be run on a computer, or in a client-server fashion over a network such as the Internet, on in communication with sites on the WorldWide Web.

The system has preferably has two operational modes: 1) Semi-automatic mode wherein operators make corrective actions in the downstream and upstream processes, and 2) Automatic (self-adaptive) Mode wherein intelligent process equipment 14 and 16 (for both upstream and downstream processes) change setup and working parameters automatically. The equipment 14 and 16 can be, for example, placement machines for placing components on a circuit board.

When the system 10 is implemented in electronics circuit board manufacturing a warning can be triggered downstream when there is 1) a component missing, 2) wrong component polarity, 3) solder joint defect, 4) solder bridge defect, 4) a component position out of range.

Thus, the sensory system 12 analyzes trends in process performance of upstream process equipment 14, and then closes the control loop by sending the trend analysis information back to the upstream process equipment 14, so that corrective action can be taken even before erroneous product is actually produced. Furthermore, the sensory system 12 forwards this information package to the downstream process equipment to alert potential problems so that adequate changes can be made.

With this real-time pre-warning and real-time related information, process equipment can be modified or adjusted quickly to eliminate all potential error sources in the process. Real time remote process diagnostic and support can be built around this concept to create a totally new service business design.

Thus, process control methodology of the embodiment also enables a new service-centric business model, which is also considered as an invention in business methods. Real time closed-loop manufacturing will allow a company to support its customers during their new process design, new product introduction, process development and manufacturing ramp-up. This closed-loop process control concept is not limited only to the process execution phase.

TABLE 1
Terminology

| Name | Description |
|---|---|
| Defects per Million | Defects will come from one of two sources |
| Opportunities DPMO | from an in-line inspection machine or |
| (The total number of | from data entered into a repair station by a repair operator. |
| defects divided by the | DPMO = Defects per million opportunities |
| total number of | DO = Number of defect opportunities |
| opportunities for a | Defect = Number of defects found |
| defect multiplied by | Boards = Number of boards inspected |
| 1,000,000) | DPMO = Defect/((Boards*DO)/1,000,000) |
| | Example: |
| | If a product has 500 part positions and 3,000 joints, the total |
| | defect opportunities are 3,500 per product |
| | If there have been 40 defects after 100 products, then the |
| | DPMO is calculated as: |
| | DPMO = 40/((100*3500)/1,000,000) |
| | DPMO = 114 |
| Upper Set point Limit | The upper limit of a control factor at which a warning should be |
| (USL) | generated. |
| Lower Set point Limit | The lower limit of a control factor at which a warning should be |
| (LSL) | generated. |
| Capability Index (Cp) | Cp is a simple process capability index that relates the allowable |
| | spread of the spec limits (spec range or the difference between the |
| | upper spec limit, USL, and the lower specification limit, LSL) to the |
| | measure of the actual, or natural, variation of the process, |
| | represented by 6 sigma, where sigma is the estimated process |
| | standard deviation. Cp is often referred to as process “potential”. |
| | $Process Capability ( Cp ) = \frac{Allowable Process Spread ( USL - LSL )}{Actual Process Spread ( 6 sigma )}$ |
| Cpk | Capability index that considers centering of the process variability |
| | with respect to the specification. While Cp relates the spread of the |
| | process relative to the specification width, it does not address how |
| | well the process average is centered to the target value. Cpk |
| | measures not only the process variation with respect to allowable |
| | specifications, it also considers the location of the process average. |
| Upper Control Limit | Statistically determined upper boundary for the variation of a process |
| (UCL) | characteristic caused by randomness |
| Lower Control Limit | Statistically determined lower boundary for the variation of a process |
| (LCL) | characteristic because of random causes alone. |

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

1. A method of executing a monitoring process during a manufacturing process to produce products, the method comprising the steps of:
measuring, in real time, performance variables of an upstream portion of a present manufacturing process,
analyzing, with a processor, trends in the performance variables of the present manufacturing process together with data that models a portion of a subsequent manufacturing process, that occurs after the present manufacture process,
sending trend analysis information to the present manufacturing process, and
sending information to the subsequent manufacturing process.

2. The method of claim 1, further including performing corrective action on the present manufacturing process based on the trend analysis information, before erroneous products are produced.

3. The method of claim 1, wherein the step of sending information includes sending information a to adjust a parameter of the subsequent manufacturing process.

4. The method of claim 1, wherein the analyzing step includes comparing a presently measured performance variable with a running average of previously measured performance variables.

5. The method of claim 4, further including performing a corrective action on the present manufacturing process when a difference between the presently measured performance variable and the running average is outside of a predetermined range.

6. The method of claim 4, wherein the analyzing step includes accessing a database to retrieve a remedy or corrective action information when a difference between the presently measured performance variable and the running average is outside of a predetermined range.

7. The method of claim 6, wherein the step of sending trend analysis information includes providing the remedy or corrective action information at the present manufacturing process.

8. A computer readable medium having stored thereon sequences of instruction for executing a monitoring process during a manufacturing process to produce products, the sequence of instructions including instructions for performing the steps of:
measuring, in real time, performance variables of an upstream portion of a present manufacturing process,
analyzing, with a processor, trends in the performance variables of the present manufacturing process together with data that models a portion of a subsequent manufacturing process, that occurs after the present manufacture process,
sending trend analysis information to the present manufacturing process, and
sending information to the subsequent manufacturing process.

9. The medium of claim 8, further including performing corrective action on the present manufacturing process based on the trend analysis information, before erroneous products are produced.

10. The medium of claim 8, wherein the step of sending information includes sending information a to adjust a parameter of the subsequent manufacturing process.

11. The medium of claim 8, wherein the analyzing step includes comparing a presently measured performance variable with a running average of previously measured performance variables.

12. The medium of claim 11, further including performing a corrective action on the present manufacturing process when a difference between the presently measured performance variable and the running average is outside of a predetermined range.

13. The medium of claim 11, wherein the analyzing step includes accessing a database to retrieve a remedy or corrective action information when a difference between the presently measured performance variable and the running average is outside of a predetermined range.

14. The medium of claim 13, wherein the step of sending trend analysis information includes providing the remedy or corrective action information at the present manufacturing process.

15. A system for preventing defects in products produced during a manufacturing process, the system comprising:
process equipment at an upstream portion of the manufacturing process,
process equipment at a portion of the manufacturing process downstream of the upstream portion of the manufacturing process,
means for measuring, in real time, performance variables of the upstream process equipment,
means for analyzing trends in the performance variables and for analyzing data modeling a downstream portion of the manufacturing process,
means for sending trend analysis information to the upstream process equipment, and
means for sending information to the downstream process equipment.
